(19) United States
(12) Patent Application Publication
(10) Pub. No.: US 2005/0289651 A1
(43) Pub. Date: Dec. 29, 2005

(54) Access method and device for securing access to information system

(76) Inventors: Daniel Fages, Neyron (FR); Mathieu Lafon, Caluire (FR); Benoit Brodart, Lyon (FR)

Correspondence Address: FULBRIGHT & JAWORSKI, LLP, 666 FIFTH AVE, NEW YORK, NY, 10103-3198, US

(21) Appl. No.: 10/537,310

(22) PCT Filed: Nov. 25, 2003
(86) PCT No.: PCT/FR03/50132

§ 371 Date: Jun. 1, 2005

(30) Foreign Application Priority Data
Dec. 2, 2002 (FR) 02/15144

(51) Int. Cl. G06F 11/00; H04K 1/00

(52) U.S. Cl. 726/23; 713/182

(57) ABSTRACT

The invention relates to a method and an access device for securing logical access to information and/or computing resources in a group of computer equipment while slowing down logical access as little as possible. The group of computer equipment exchanges data with a computer telecommunication network, via said access device. The data include transported data that conform to at least one application protocol, as well as transport data. The access device comprises an operating system that includes an appropriate analysis module for each applicative protocol, filtering means for filtering said transported data in said operating system, by means of said analysis modules.

The present invention concerns a method and a device for securing access to information systems.

Definitions

In the sense of the present invention, the term “applications” generally designates software applications in the communications field.

In the sense of the present invention, “application” protocol generally designates a protocol that governs the exchange of information between applications.

In the sense of the present invention, “application” attack designates an attack that uses:
either the vulnerabilities of an “application” protocol,
or the vulnerabilities linked to the implementation of an “application” protocol by a developer,
or the vulnerabilities linked to the use of an application, particularly by a network administrator.
   The Problem Posed

Context: Security of access to information systems

All experts agree on the fact that the risk linked to computer security is significantly on the rise.

What are the factors in the growth of this risk?

Three main factors have been identified.

First risk factor: the exponential growth in the number of pirates.

The number of internet users has doubled in three years. They make use of free toolboxes available on the net. International legislation aimed at reducing fraud is nonexistent; for example, in Japan there are no cyber-delinquency laws. Moreover, there is a new type of pirate emerging in high schools and on university campuses, for whom piracy is a game and cracking the largest number of sites is a competition. These computer pirates, commonly known as “script kiddies,” have very little technical know-how, but they are able to use program “toolboxes,” generally found on the Internet, that make it possible to attack computer systems.

Second risk factor: the globalization of trade.

In the era of cost reduction and the communicating company, companies are obliged to use efficient communication media like the Internet that allow the use of email exchanges, e-commerce sites, and EDI (electronic data interchange).

Companies are exchanging more and more documents. These documents contain more and more information. This information is of greater and greater value.

Moreover, companies have to move quickly. They do not always take all the precautions they ought to take.

Third risk factor: as companies open up worldwide, information systems are also increasingly open to the outside. Information systems are interconnected. A company's LAN (Local Area Network) becomes one of the stations in the global network.

It is also clear that information systems are becoming more and more complex. Because of this, they have bugs—in other words, holes in their security. In addition, complex information systems are difficult to manage, and consequently, difficult to secure.

The 2001 CERT (Computer Emergency Response Team) statistics listed, 52,658 incidents in 2001, or an increase of 142% relative to 2000.

How does one succeed in penetrating a computer system?

Nearly all vulnerability attacks can be divided into three categories:

(a) Attacks that exploit a weakness in the protocols used (for example IP Sniffing). IP Sniffing is a technique that consists of intercepting a communication in a network in order to obtain information.

(b) Attacks that exploit a bug found in the TCP/IP stack of the operating system. Certain attacks are known as “Ping of Death” or “Teardrop” attacks.

Let's briefly review, in the sense of the present invention, the following abbreviations:
TCP: Transmission Control Protocol; designates a transport protocol (OSI Level 4) used in the TCP/IP family of protocols.
TCP/IP: Transmission Control Protocol/Internet Protocol; designates a family of protocols used in the interconnection of IP-type networks.

(c) “Application” attacks use the transported data. These include, in particular, “application” attacks that exploit bugs in a system's communication applications, for example security holes in the DNS/BIND servers or IIS web servers.

Let's briefly review, in the sense of the present invention, the following abbreviations:
DNS (Domain Name System) designates an “application” protocol that allows the system name (for example, www.yahoo.com) to be converted into an IP address (for example (123.234.231.135),
IP (Internet Protocol) designates a network protocol (OSI Level 3) used on the Internet.

It is clear from the statistics that the vast majority of the vulnerabilities discovered are on the level of “application” attacks. Thus, the main threat exists at the level of the security holes in communication applications.

The problem posed by the present invention is to reduce the risks of “application” attacks.

The Prior Art

There are two known technologies for solving the problem posed and providing IP network security:

The technology hereinafter referred to as “Stateful” technology.

The technology hereinafter referred to as “Proxy” technology.

(a) “Stateful” technology, otherwise known as maintaining an active connection table

(a1) “Static packet filtering” technology

The first functionalities for protecting IP networks were integrated into routers. Routers incorporate a static IP packet filtering mechanism. Based on the information read in the header of an IP packet, at the level of the Network and Transport headers, the packet is accepted or rejected in accordance with a list of filtering rules defined by an administrator. The chief drawback of this technology is its static aspect. It cannot attach a “response packet” to a “request packet” sent a few moments earlier. Consequently, when using a “static packet filtering” technology, one is obliged to accept all the “response packets' without being able to attach them to the requests sent previously. This creates a problem in terms of security since one need only, for example, set the ACK flag in the TCP header of a packet in order for this packet to be accepted by the router. Let's briefly recall that in the sense of the present invention, the abbreviation ACK (ACKnowledgement) designates a flag used in a TCP-type header.

(a2) “Stateful” technology

“Stateful” technology partially overcomes this drawback by maintaining an active connection table, which makes it possible to attach the “response packets” to the “request packets” sent previously. In addition, this technology generally involves reading information in the transported data, as opposed to the information contained in the header of the packet, in order to be able to manage secondary connections, based on dynamic ports. For example, any FTP transfer uses a dynamic secondary connection, wherein the ports are negotiated via the control connection in the TCP/21 port. Let's briefly recall that in the sense of the present invention the abbreviation FTP (File Transfer Protocol) designates a protocol used to transfer files in a TCP/IP-type network.

“Stateful” technology is generally implemented in a system's kernel, or embedded in a real-time system, which ensures good performance in terms of speed. However, “Stateful” technology does not make it possible to ensure conformity with the “application” protocols during a data exchange, since “Stateful” technology is limited to extracting from the transported data the information required to establish and maintain secondary connections. Yet as explained above, the risks of attack exist mainly at the level of the transported data.

(b) “Proxy” technology

In the case of “Proxy” technology, otherwise known as “Agent” technology, the client does not address the server directly. For example, the browser, also known as the navigator, connects to the Web server, also called the network server, by going through a “proxy” that performs the request in its place and sends back the response.

This technology makes it possible to filter the transported data, which is a clear advantage in terms of security. On the other hand, the fact that it is implemented as an application located “above” the operating system makes it much less efficient in terms of speed than “Stateful” technology. This major drawback of “Proxy” technology results in inadequate performance in terms of the desired speeds in IP networks.

Conclusion

The drawbacks of the known solutions may be summarized as follows.

In “Stateful” technology, the security is inadequate.

In “Proxy” technology, the speed is inadequate.

The Solution According to the Invention

The technology proposed by the present invention will hereinafter be designated by the abbreviation FAST, for Fast Application Shield Technology. FAST technology solves the problem posed while avoiding the drawbacks of the known “Stateful” and “Proxy” technologies. FAST technology makes it possible to secure access to information systems while avoiding the risk of “application” attacks and limiting the loss of speed.

Method

The invention concerns a method for securing logical access to information and/or computing resources in a group of computer equipment while slowing down logical access as little as possible. The group of computer equipment exchanges data with a computer telecommunication network, via an access device. The data include transported data that conform to at least one application protocol, as well as transport data. The access device includes an operating system.

The method according to the invention comprises the following steps:

the step of defining, for each application protocol, a finite-state machine,

the step of modeling, in the form of a model, each finite-state machine,

the step of generating from each model, by means of an interpreter, an analysis module for each application protocol,

the step of filtering the transported data in the operating system, by means of the analysis modules.

Preferably, according to the invention, the method also comprises the step of verifying, by means of the analysis modules, the conformity of the transported data with the application protocols involved.

Preferably, according to the invention, the method also comprises the step of restricting, by means of the analysis module, the capabilities offered by an application protocol.

As a result of the combination of these two functionalities (Verify and Restrict), the technology according to the invention makes it possible to detect and block a large number of “application” attacks. These two functionalities have been shown to detect and block 90% of the known attacks on Apache and IIS Web servers without its being necessary to integrate an “attack signature base” into them, as in the case of intrusion detection systems.

Preferably, according to the invention, the method also comprises the step, for a network administrator, of parameterizing the analysis modules in accordance with predetermined restrictions.

Device

The invention also concerns an access device for securing logical access to information and/or computing resources in a group of computer equipment while slowing down logical access as little as possible. The group of computer equipment exchanges data with a computer telecommunication network, via the access device. The data include transported data that conform to at least one application protocol, as well as transport data.

The access device includes:

an operating system that includes an appropriate analysis module for each application protocol,

filtering means for filtering the transported data in the operating system, by means of the analysis modules.

Preferably, according to the invention, each analysis module implements a finite-state machine representing a given application protocol.

Preferably, according to the invention, the analysis modules include first information processing means for verifying the conformity of the transported data with the application protocols involved.

Preferably, according to the invention, the analysis modules include second information processing means for restricting the capabilities offered by an application protocol.

Preferably, according to the invention, the access device also comprises parameterization means that allow a network administrator to parameterize the analysis modules in accordance with predetermined restrictions.

### DETAILED DESCRIPTION

Other characteristics and advantages of the invention will emerge through the reading of the description of variants of embodiment of the invention given as illustrative and nonlimiting examples, and from:

FIG. 1, which schematically represents a local area network 3 protected by a device 6 according to the invention against attacks originating from an Internet-type computer communication network,

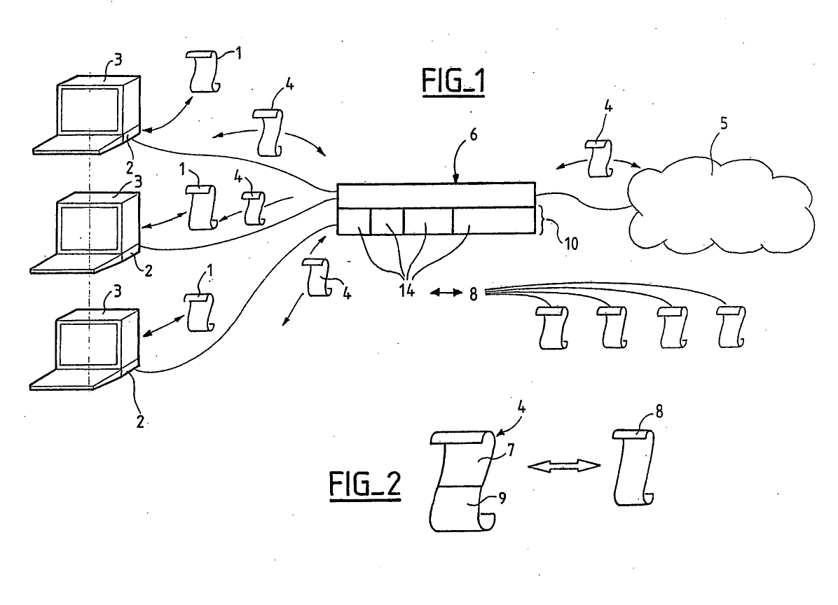

FIG. 2, which represents the structure of the data 4 exchanged via a device 6 according to the invention,

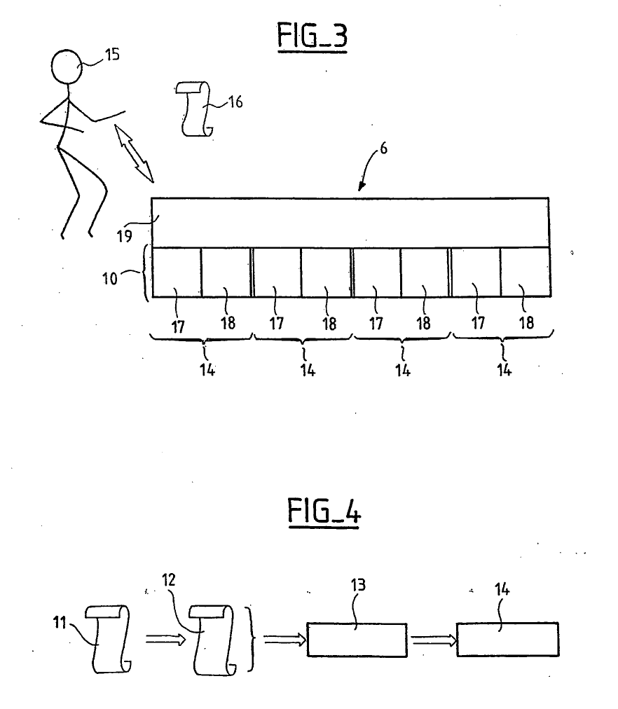

FIG. 3, which schematically represents a device 6 according to the invention,

FIG. 4, which schematically represents the method for constructing an analysis module 14 from a finite state machine.

Referring to the figures, and particularly FIG. 1, we will now describe a local area network 3 protected by a device 6 according to the invention against attacks originating from an Internet-type computer communication network 5.

The purpose of the access device 6 is to secure logical access to information 1 and/or computing resources 2 in a group of computer equipment 3 while slowing down said logical access as little as possible.

The group of computer equipment 3 exchanges data 4 with a computer telecommunication network 5, via said access device 6. In the case of the variant of embodiment described, the computer telecommunication network 5 is an Internet-type network. The computer equipment 3 can be servers, workstations, etc.

In an intrinsically known way, the data 4 include transported data 7 that conform to at least one application protocol 8, as well as transport data 9 (see FIG. 2).

The access device 6 according to the invention includes an operating system 10. The operating system 10 includes appropriate analysis modules 14 for each application protocol used 8. The analysis modules 14 of the operating system 10 filter the transported data 7.

Each analysis module 14 implements a finite-state machine 11 representing a given application protocol 8. In order to create an analysis module 14, each finite-state machine 11 is modeled in the form of a model 12, particularly by using a state transition matrix. Next, the analysis module 14 for each application protocol 8 is generated, by means of an interpreter 13, from each model 12 (see FIG. 4).

Each analysis module 14 includes first information processing means 17 for verifying the conformity of the transported data with the application protocols 8 involved. Each analysis module 14 also includes second information processing means 18 for restricting the capabilities offered by an application protocol 8.

The operating system and the associated analysis modules 14 constitute means for filtering the transported data 7.

The access device 6 also comprises parameterization means 19. These parameterization means 19 allow a network administrator 15 to parameterize the analysis modules 14 in accordance with predetermined restrictions 16, as will be explained below.

As a result of the access device 6 according to the invention, it is possible to verify proper conformity with the application protocols, which makes it possible to block a very large number of “application” attacks without knowing what they are, including those that violate the RFCs (“IP standards”). Let's briefly recall that in the sense of the present invention, the abbreviation RFC (Request for Comment) designates various standard-setting documents in which the various protocols of the TCP/IP family are specified.

In addition, the technology according to the invention makes it possible to restrict the capabilities offered by an application. For example, the technology according to the invention makes it possible to limit the commands available in an “application” protocol or to only authorize access to certain data, etc.

As a result of the combination of these two functionalities, (Verify and Restrict), the technology according to the invention makes it possible to detect and block a large number of “application” attacks. These two functionalities have been shown to detect and block 90% of the known attacks on Apache and IIS Web servers without its being necessary to integrate an “attack signature base” into them, as in the case of intrusion detection systems.

The technology according to the invention was developed on a Linux operating system. It is within the capability of one skilled in the art to implement it in other systems of the same type.

LIST OF TERMS

| Term | Ref. Num. |
|---|---|
| Information | 1 |
| computing resources | 2 |
| group of computer equipment | 3 |
| Data | 4 |
| computer telecommunication network | 5 |
| access device | 6 |
| transported data | 7 |
| application protocol | 8 |
| transport data | 9 |
| operating system | 10 |
| finite-state machine | 11 |
| Model | 12 |
| Interpreter | 13 |
| analysis module | 14 |
| network administrator | 15 |
| predetermined restrictions | 16 |
| first information processing means | 17 |
| second information processing means | 18 |
| parameterization means | 19 |

1-9. (canceled)

10. Method for securing logical access to information and/or computing resources in a group of computer equipment while slowing down said logical access as little as possible, said group of computer equipment exchanging data with a computer telecommunication network via an access device comprising an operating system, and said data comprising transported data that conform to at least one application protocol, as well as transport data, said method comprising the steps of:
defining a finite-state machine for each application protocol;
modeling each finite-state machine in the form of a model;
generating from each model, an analysis module for each application protocol by means of an interpreter; and
filtering the transported data in said operating system by means of said analysis modules.

11. The method of claim 10, further comprising the step of verifying the conformity of said transported data with the application protocols involved by means of said analysis modules.

12. The method of claim 10, further comprising the step of restricting the capabilities offered by an application protocol by means of said analysis module.

13. The method of claim 11, further comprising the step of restricting the capabilities offered by an application protocol by means of said analysis module.

14. The method of claim 12, further comprising the step of parameterizing said analysis modules in accordance with predetermined restrictions by a network administrator.

15. An access device for securing logical access to information and/or computing resources in a group of computer equipment while slowing down said logical access as little as possible, said group of computer equipment exchanging data with a computer telecommunication network via said access device, and said data comprising transported data that conform to at least one application protocol, as well as transport data, said access device comprising:
an operating system that includes an appropriate analysis module for each application protocol;
a filtering module for filtering said transported data in said operating system by means of said analysis modules.

16. The access device of claim 15, wherein each analysis module implements a finite-state machine representing a given application protocol.

17. The access device of claim 15, wherein said analysis modules comprises a first information processing module for verifying the conformity of said transported data with said application protocols involved.

18. The access device of claim 15, wherein said analysis modules comprises an information processing module for restricting the capabilities offered by an application protocol.

19. The access device of claim 18, further comprising a parameterization module for parameterizing said analysis modules in accordance with predetermined restrictions by a network administrator.

20. The access device of claim 16, wherein said analysis modules comprises a first information processing module for verifying the conformity of said transported data with said application protocols involved.

21. The access device of claim 16, wherein said analysis modules comprises an information processing module for restricting the capabilities offered by an application protocol.

22. The access device of claim 17, wherein said analysis modules comprises a second information processing module for restricting the capabilities offered by an application protocol.
